(19) United States
(12) Patent Application Publication
(10) Pub. No.: US 2017/0088231 A1
(43) Pub. Date: Mar. 30, 2017

(54) Human-Propellable Vehicle

(71) Applicant: Gower College Swansea, Swansea South Glamorgan (GB)

(72) Inventors: Calvin John Llewelyn Williams, Swansea South Glamorgan (GB); Paul Howard Davies, Ammanford Dyfed (GB)

(21) Appl. No.: 15/308,301

(22) PCT Filed: Apr. 29, 2015
(86) PCT No.: PCT/GB2015/051249

§ 371 Date: Nov. 1, 2016

(30) Foreign Application Priority Data
May 2, 2014 (GB) 1407774.7

(51) Int. Cl. B62K 25/04; B62K 5/06; B62J 1/00; B62K 21/08; B62K 21/12; B62D 1/04; B62K 5/003; B62K 5/08

(52) U.S. Cl. CPC B62K 25/04; B62K 5/003; B62K 5/06; B62K 5/08; B62K 21/08; B62K 21/12; B62D 1/04; B62J 1/002; B62K 2005/001

(57) ABSTRACT

A human-propellable vehicle (1) is described which comprises a chassis (2), and a rear wheel assembly (5) mounted to a rear portion of the chassis. The rear wheel assembly comprises a double wishbone suspension assembly, each wishbone (14, 22) of the double wishbone suspension assembly being coupled to the chassis at first and second coupling points, the second coupling point for each wishbone being closer to the rear of the chassis, and closer to the longitudinal axis of the vehicle, than the first coupling point for that wishbone. By using a double wishbone set up at the rear of the bike it is possible to control weight transfer more efficiently. By providing a second coupling point for each wishbone which is closer to the rear of the chassis, and closer to the longitudinal axis of the vehicle, than the first coupling point for that wishbone, it is possible to utilise a setup without having to adopt a higher seating position and without having to increase the rear wheel track beyond an acceptable width.

### FIELD OF THE INVENTION

The present invention relates to a human-propellable vehicle. Embodiments of the present invention relate to a three or four wheeled bike having improved suspension. One embodiment of the present invention relates to a four wheel bicycle with gravity propulsion in which the suspension geometry and mounting points of the suspension components may improve vehicle dynamics.

### BACKGROUND TO THE INVENTION

A four wheel gravity propelled downhill bicycle primarily aimed at disabled riders may require a wheel chair type appearance to the rear of the vehicle, to be suitable for the disabled rider. In particular, the bikes need to resemble a wheel chair at the rear to enable self-propulsion of the bike when not assisted by gravity. As a result, previous bikes tend to place the rider right at the back of the bike to achieve the “wheel chair” type design. However this creates a problem in as much as the weight distribution is not favourable to the application of the bicycle, placing most of the rider's weight on the rear wheels and over-working the rear damper units, which would typically be part of a trailing-arm type suspension assembly. As a result the bicycle becomes unstable over consecutive obstacles and can overturn with little effort.

In seeking to solve this problem, there is a particular constraint to the overall size of the bike because the length and width need to firstly allow the bike to fit on existing downhill trails and also allow the bike to fit in most estate cars currently available. Moreover, the rear-wheel track must be sufficiently narrow to allow the rider to be able to manipulate the rear wheels to self-propel the vehicle when not travelling downhill.

Embodiments of the present invention seek to address these problems.

### SUMMARY OF THE INVENTION

According to an aspect of the present invention, there is provided a human-propellable vehicle, comprising a chassis, and a rear wheel assembly mounted to a rear portion of the chassis. The rear wheel assembly comprises a double wishbone suspension assembly, each wishbone of the double wishbone suspension assembly being coupled to the chassis at first and second coupling points, the second coupling point for each wishbone being closer to the rear of the chassis, and closer to the longitudinal axis of the vehicle, than the first coupling point for that wishbone.

In general terms, the new design replaces the suspension trailing arms on the rear of the vehicle with a double wishbone type set up, which significantly moves the pivot point of the rear suspension from being in front of the rider to being in line with the rider's torso. This type of set up reduces the wheel to damper motion ratio which in turn reduces the workload of and increases the lifespan of the damper and suspension components. This also allows for a more controlled vehicle dynamic resulting in more consistency over consecutive obstacles and reduces the potential for overturning the bicycle. By using a double wishbone set up at the rear of the bike instead of the more conventional trailing arm type set up it is possible to control weight transfer more efficiently.

While double wishbone suspension is well-known for motorised vehicles, it has not previously been possible to implement double wishbone suspension on a human-propelled vehicle while satisfying the vehicle dimension requirements referred to above. This is because a double wishbone suspension assembly extends laterally (sideways) from the body of a vehicle. In the case of a downhill bike the wishbones cannot be provided directly underneath the body because this would result in a higher seating position for the rider, thereby reducing stability. However, if the wishbones extend out from the side of the vehicle, the rear wheel track becomes too wide, with the result that the vehicle cannot operate on existing downhill trails, and cannot be comfortably self-propelled by manipulation of the rear wheels. However, the present invention, by providing a second coupling point for each wishbone which is closer to the rear of the chassis, and closer to the longitudinal axis of the vehicle, than the first coupling point for that wishbone, is able to utilise a double wishbone type suspension setup without having to adopt a higher seating position and without having to increase the rear wheel track beyond an acceptable width. In this way, a vehicle design which can achieve the size required and also improve upon the handling performance currently available can be provided.

Preferably, each upper wishbone of the double wishbone suspension assembly is shaped to extend around the outside edge of the chassis from the first coupling point to the second coupling point. In this way, the wishbone does not interfere with the chassis when it moves to absorb a bump or dip in the terrain. Similarly, preferably each lower wishbone of the double wishbone suspension assembly is shaped to extend around the outside edge of the chassis from the first coupling point to the second coupling point, for the same reasons. As a result of the locations of the coupling points, and the shape of the wishbones, the axis of rotation of each wishbone of the double wishbone suspension assembly effectively intersects the rear portion of the chassis. This would not normally be the case for a low slung vehicle, in which the axis of rotation of a double wishbone suspension setup would be expected to be beyond the outer perimeter of the chassis. It will be understood that the amount of travel available in a suspension system is a function of how far the wishbones extend from their axis of rotation. Because in the present design the axis of rotation is effectively within the confines of the chassis, the wishbones can extend far enough from their axis of rotation to perform their intended function, without needing to extend much beyond the outer edge of the chassis.

When assembled, the vehicle comprises a seat, mounted to the chassis between the first coupling points and the second coupling points of the double wishbone suspension assembly. This seating position means that the rider's weight is disposed directly on top of the rear suspension, rather than being behind the rear suspension point as is the case with trailing arm designs.

The suspension assembly may comprise a pair of dampers, each damper being mounted between a third coupling point on the chassis and one of the lower wishbones of the double wishbone suspension assembly.

Each wishbone of the double wishbone suspension assembly may comprise a first arm having at one end a ball joint engaged with the chassis at the first coupling point, and a second arm having at one end a ball joint engaged with the chassis at the second coupling point, the first and second arms extending around part of the perimeter of the chassis to meet. The second coupling point may be at substantially the rearmost part of the chassis. This is advantageous in that the both the rear suspension and the seat can be provided as close to the rear of the vehicle as possible.

Preferably, the chassis is a frame structure of tubular members, and the second coupling point of each of the wishbones is on a rear tubular member of the chassis frame which forms the rear of the chassis.

Preferably, the second coupling point for each wishbone is approximately half of the horizontal distance from the longitudinal axis than the first coupling point of that wishbone. This configuration enables the wishbones to have sufficient travel to absorb shocks from terrain features without requiring the wishbones to extend a substantial distance from the chassis.

Preferably, the first coupling point of each upper wishbone is at a horizontal distance of between approximately 175 mm and 200 mm from the longitudinal axis. More preferably, the first coupling point of each upper wishbone is at a horizontal distance of approximately 190 mm from the longitudinal axis. Preferably, the first coupling point of each lower wishbone is at a horizontal distance of between approximately 150 mm and 175 mm from the longitudinal axis. More preferably, the first coupling point of each lower wishbone is at a horizontal distance of approximately 160 mm from the longitudinal axis.

Preferably, the second coupling point of each wishbone is at a horizontal distance of between approximately 0 mm and 150 mm from the longitudinal axis. More preferably, the second coupling point of each wishbone is at a horizontal distance of less than approximately 125 mm from the longitudinal axis. Still more preferably, the second coupling point of each wishbone is at a horizontal distance of greater than approximately 50 mm from the longitudinal axis. Even more preferably, the second coupling point of each upper wishbone is at a horizontal distance of approximately 100 mm from the longitudinal axis, and the second coupling point of each lower wishbone is at a horizontal distance of approximately 75 mm from the longitudinal axis.

Preferably, the double wishbone suspension assembly of the rear wheel assembly comprises upper wishbones and lower wishbones, the upper wishbones extending further from their axis of rotation than the lower wishbones.

Preferably, a front wheel assembly is mounted to a front portion of the chassis, the front wheel assembly comprising a double wishbone suspension assembly, the double wishbone suspension assembly of the front wheel assembly having a positive caster. By providing the front double wishbone assembly with a positive caster, the front steering tends to self-centralise if the rider lets go of the steering wheel or handlebars.

Preferably, the double wishbone suspension assembly of the front wheel assembly comprises upper wishbones and lower wishbones, the upper wishbones extending further from their axis of rotation than the lower wishbones.

Preferably, the vehicle is a three or four wheeled bike. While the vehicle described herein is entirely human and gravity propelled, in some alternative embodiments a motor may be provided to assist the human propulsion of the vehicle. However, even where a motor is present, such a vehicle is still human propellable if the rider is able to manually propel it by turning the rear wheels (for example).

It will be appreciated that while embodiments of the present invention are particularly beneficial for disabled riders, they can also be used by able bodied riders.

### DETAILED DESCRIPTION

The invention will now be described by way of example with reference to the following Figures in which:

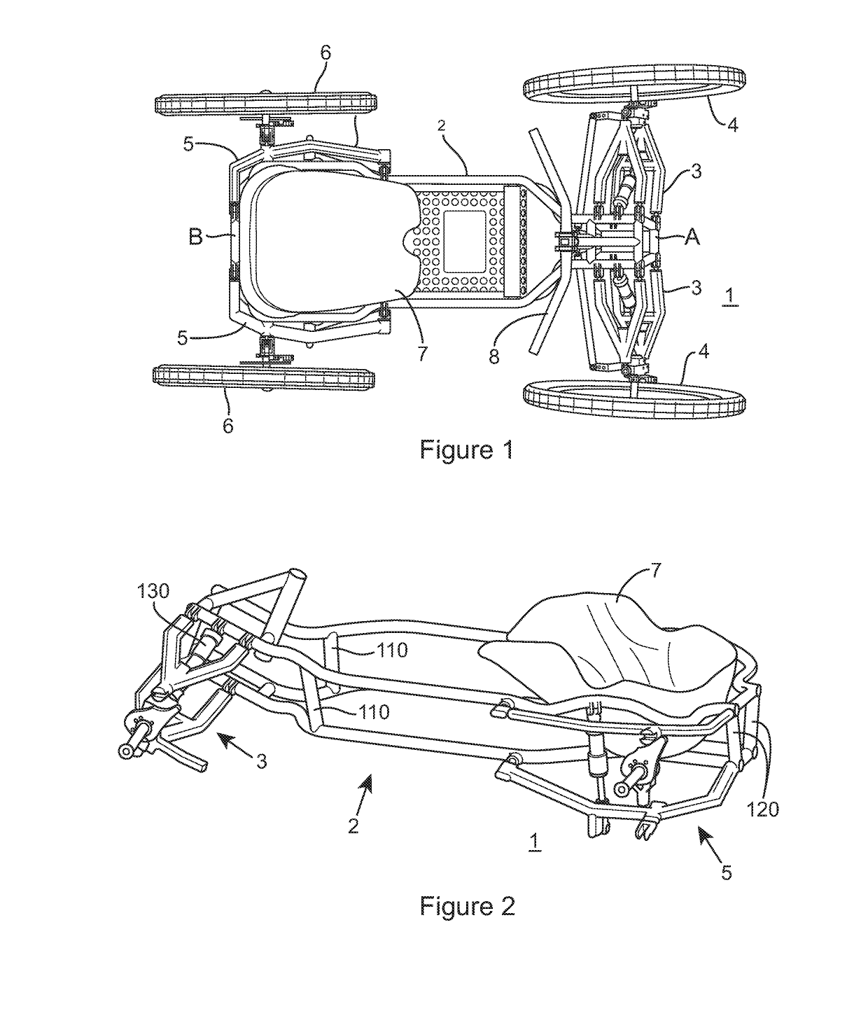

FIG. 1 schematically illustrates a top view of a human-propelled vehicle;

FIG. 2 schematically illustrates a 3D view of the human-propelled vehicle;

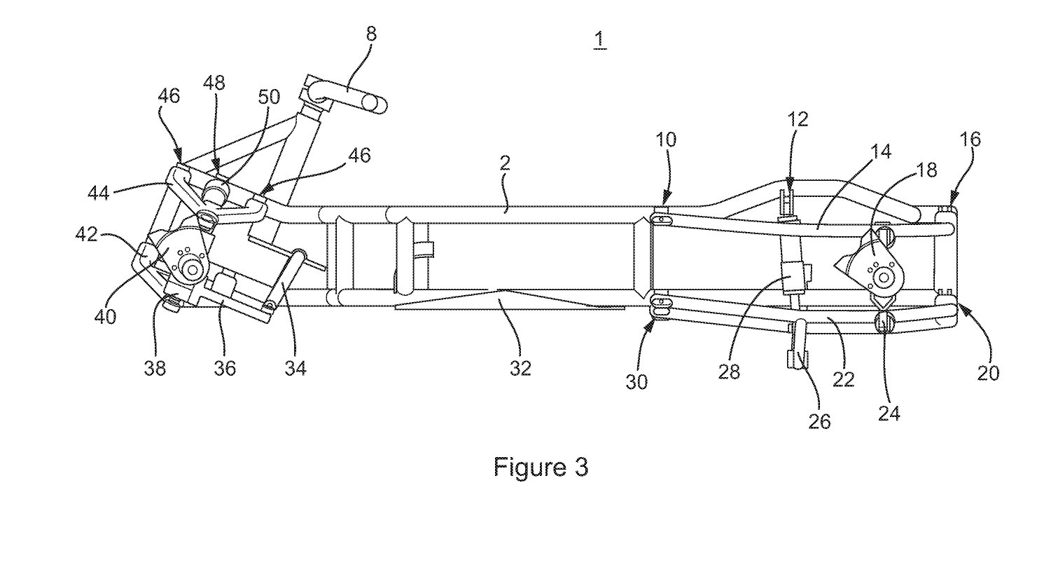

FIG. 3 schematically illustrates a side view of the human-propelled vehicle;

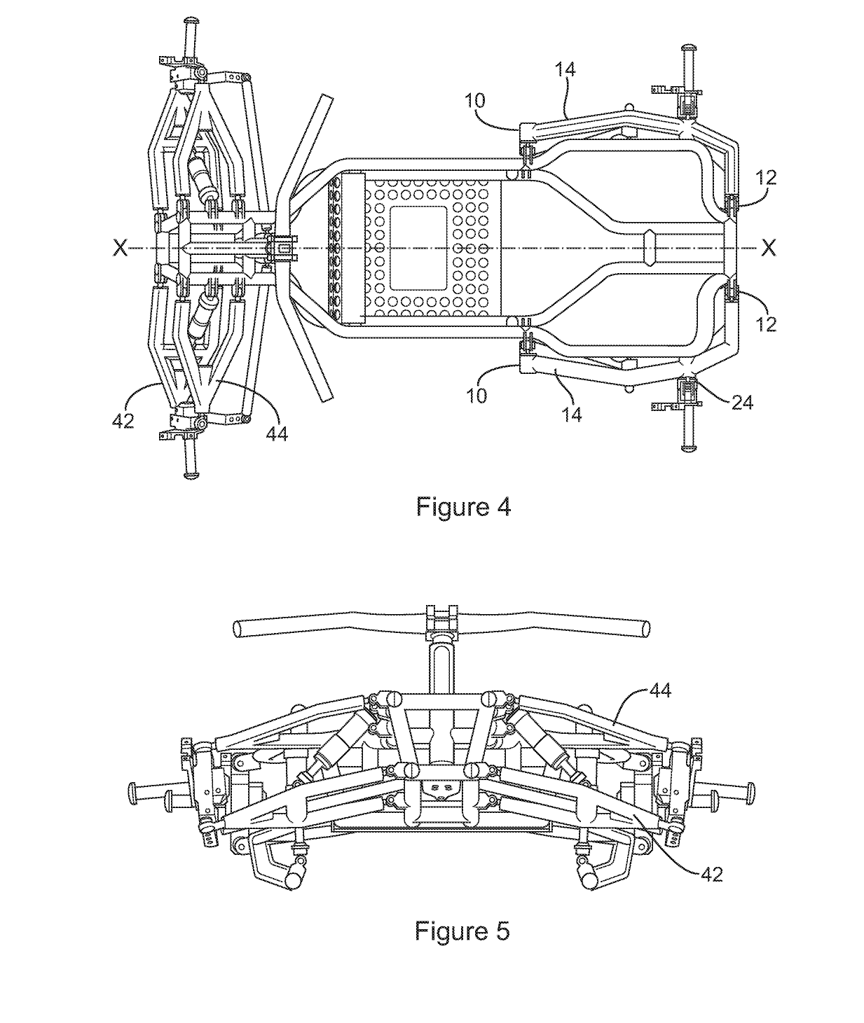

FIG. 4 schematically illustrates another top view of the human-propelled vehicle;

FIG. 5 schematically illustrates a front view of the human-propelled vehicle;

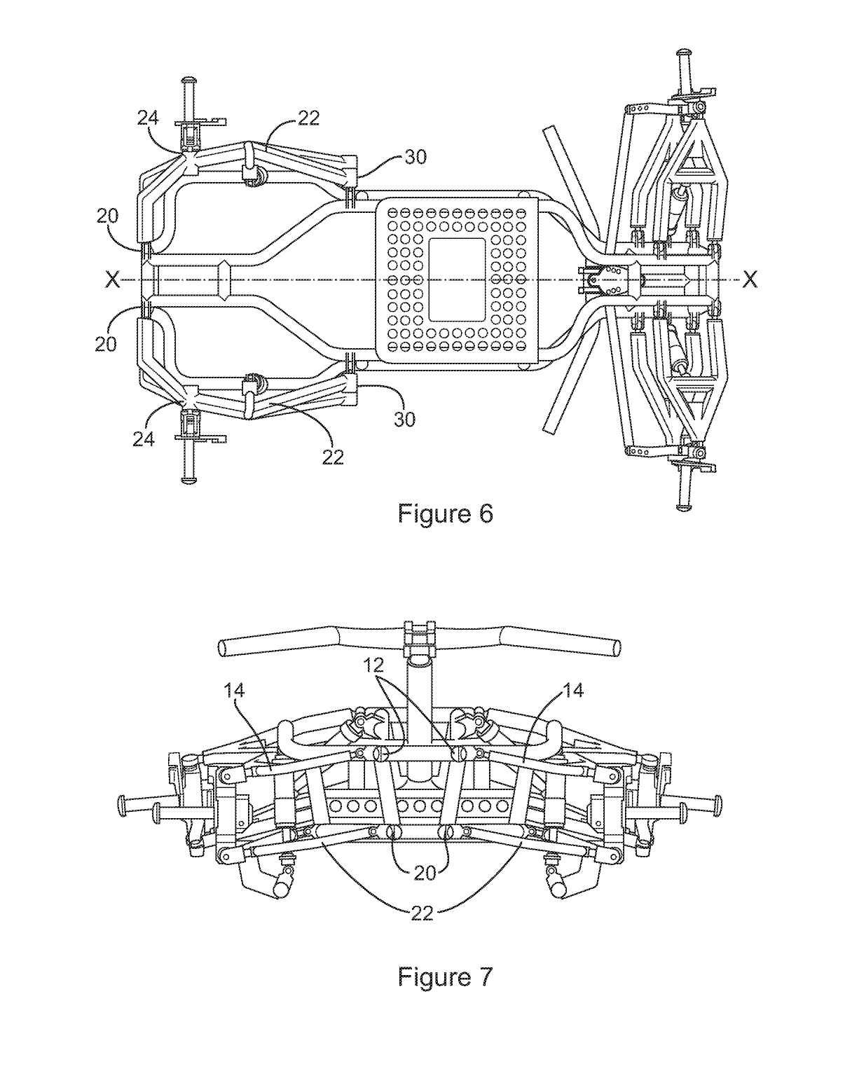

FIG. 6 schematically illustrates a bottom view of the human-propelled vehicle; and

FIG. 7 schematically illustrates a rear view of the human-propelled vehicle.

Referring first to FIG. 1, a top down view of a human propelled vehicle 1 is shown. The human propelled vehicle 1 comprises a chassis 2, a front wheel assembly 3, front wheels 4, a rear wheel assembly 5, rear wheels 6, a seat 7 and handlebars 8. In use, a rider sits in the seat 7 and is able to use his hands to manipulate the handlebars 8 to control a steering function of the front wheel assembly 3. In the present example the vehicle is propelled only by the rider, by manipulating the rear wheels 6 in the manner of propulsion of a wheelchair, or under gravity when on a downhill track. The chassis is approximately 1200 mm in length from the point A to the point B (marked on FIG. 1). The distance between the front wheel axles and the rear wheel axles (wheelbase) is approximately 1024 mm. Preferably the wheels 4, 6, are spoked wheels.

Referring to FIG. 2, a 3D view of the vehicle of FIG. 1 is shown. From FIG. 2 it can be seen that the chassis 2 effectively comprises two horizontal layers. The seat 7 rests within a space between the two layers towards the rear of the chassis 2. The bottom of the seat 7 is above the lower of the two layers of the chassis 2, and the top of the seat 7 is above the upper of the two layers of the chassis 2. It can be seen also that the front wheel assembly 3 and the rear wheel assembly 5 are each attached both to the upper and lower layers of the chassis 2. The upper and lower layers of the chassis 2 are rigidly joined together by way of a plurality of substantially upright members 110, 120, 130.

Referring to FIG. 3, a side view of the vehicle of FIGS. 1 and 2 is shown. The vehicle 1 as shown in FIG. 3 (and the remaining Figures) is shown without certain elements such as the wheels and seat, in the interests of clarity. In FIG. 3, the vehicle 1 can be seen to comprise a footplate 32 on which the rider can place his feet. The footplate 32 is mounted to the lower layer of the chassis 2. The front wheel assembly 3 can be seen to comprise a front brake calliper mount 40 on which a brake, and the wheel 4, can be mounted. A front upper wishbone 44 and a front lower wishbone 42 are mounted respectively to the upper and lower layers of the chassis 2. It will be noted that the front portion of the chassis 2 to which the wishbones are mounted is inclined (at an angle of approximately 22° in the present example) with respect to the remainder of the chassis 2, to provide the front wheel assembly 3 with a positive caster, to aid stability and provide a tendency for the wheels 4 to self-centre when the rider takes his hands off of the handlebars 8 (for example to manipulate the rear wheels 6). The front upper wishbone 44 is mounted to the inclined part of the upper layer of the chassis 2 by upper wishbone mounts 46. The front upper wishbone 44 and front lower wishbone 42 are joined together at a furthest point from the chassis 2 by a front upright 38, to which the front brake calliper mount 40 is fixed. A damper 50 is attached at one end to the upper layer of the chassis 2 at a point 48 between the two upper wishbone mounts 46, and at its other end to the front lower wishbone 42. The damper 50 absorbs impacts transmitted through the wheels 4 and the front wheel assembly 3 when the vehicle travels across bumps and dips in the terrain. A steering arm 36 and a steering rod 34 are provided which translate rotational movement of the handlebars 8 by the rider into rotation of the front brake calliper mount 40 and wheels 4.

At the rear of the chassis 2, the rear wheel assembly 5 is shown to comprise an upper rear wishbone 14 and a lower rear wishbone 22, which are mounted respectively to the upper and lower layers of the chassis 2. The rear upper wishbone 14 is mounted to the upper layer of the chassis 2 by a front upper wishbone mount 10 and a rear upper wishbone mount 16. The rear lower wishbone 22 is mounted to the lower layer of the chassis 2 by a front lower wishbone mount 30 and a rear lower wishbone mount 20. The rear upper wishbone 14 and rear lower wishbone 22 are joined together at a furthest point from the chassis 2 by a rear upright 24, to which a rear brake calliper mount 18 is fixed. A damper 28 is attached at one end to the upper layer of the chassis 2 at a point 12 between the two upper wishbone mounts 10, 16, and at its other end to a point 26 on the front lower wishbone 22. The damper 28 absorbs impacts transmitted through the wheels 6 and the rear wheel assembly 5 when the vehicle travels across bumps and dips in the terrain. It should be understood that the term upright when applied to the member joining the upper and lower wishbones (of both the front and rear suspension assemblies) does not necessarily mean that these members are strictly vertical—they may be at an inclined angle with respect to the vertical.

The wishbone mounts described above are ball joints (spherical bearings), permitting the wishbones to rotate about an axis. Other joints may also be used, provided that they permit the wishbones to rotate about an axis which intersects both coupling points of a wishbone.

It can be seen that the position at which the damper 28 connects to the rear lower wishbone 22 is not the same as the position of the upright 24. It will be appreciated that different positions along the length of the rear lower wishbone 22 will provide different amounts (distances) of vertical travel for a given amount of rotation of the rear lower wishbone 22, depending on the distance of those points from the rotational axis of the rear lower wishbone 22. The position on the rear lower wishbone 22 furthest from its rotational axis will be subject to the greatest amount of vertical travel. As a result, each of the damper 28 and the upright 24 (on which is mounted the wheel 6) can be positioned on the rear lower wishbone at a position most suitable for its intended purpose. In particular, the upright 24 is positioned to achieve maximum travel (for the wheel 6), while the damper 28 is positioned to provide an appropriate amount of travel for the characteristics of the damper 28. It will be appreciated that in other embodiments the damper 28 and the upright 24 may be coupled at the same position on the lower wishbone 22.

Referring to FIG. 4, a top view of the vehicle 1 is shown, in which the longitudinal axis X-X of the vehicle is marked. It can be seen that the front upper wishbone 44 is shorter (extends less far from its mounting point to the chassis) than the front lower wishbone 42. This can also be seen clearly from FIG. 5, which provides a front view of the vehicle 1. The use of a shorter upper wishbone induces negative camber when the suspension is compressed (rises), improving stability on cornering. Preferably the front wheel assembly is configured so that the vehicle operates with a small negative camber as standard, which slows the vehicle down slightly to be more controllable. It can also be seen that the front upper wishbone mount 10 is further from the longitudinal axis X-X (center line) of the vehicle than the rear upper wishbone mount 16. The rear upper wishbone mount 16 is mounted to a rear tubular member of the chassis 2. The rear upper wishbone 14 can be seen to extend from the front upper wishbone mount 10 to the rear upper wishbone mount 16 in a shape which remains close to an outer edge of the (upper layer of the) chassis 2. The rear upper wishbone 14 can be seen to extend in a relatively direct path (with only one small bend) from the front upper wishbone mount 10 to the rear upright 24, but to extend in a sharply angled path from the rear upright 24 to the rear upper wishbone mount 16. This configuration keeps the rear upper wishbone 14 outside the perimeter of the chassis 2 to prevent the chassis 2 and the rear upper wishbone 14 from interfering with each other. However, the axis of rotation of the rear upper wishbone 14 extends directly from the front upper wishbone mount 10 to the rear upper wishbone mount 16, and thus (a) intersects the chassis, and (b) is non-parallel with the longitudinal axis of the vehicle—both of which are characteristics which are not expected of a double wishbone suspension assembly.

Referring to FIG. 6, a bottom view of the vehicle 1 is shown, in which the longitudinal axis X-X of the vehicle is marked. It can be seen from FIG. 6 that the front lower wishbone mount 30 is further from the longitudinal axis X-X of the vehicle than the rear lower wishbone mount 20. The rear lower wishbone 22 can be seen to extend from the front lower wishbone mount 30 to the rear lower wishbone mount 20 in a shape which remains close to an outer edge of the (lower layer of the) chassis 2. The rear lower wishbone 22 can be seen to extend in a relatively direct path (with only one small bend) from the front lower wishbone mount 30 to the rear upright 24, but to extend in a sharply angled path from the rear upright 24 to the rear lower wishbone mount 20. This configuration keeps the rear lower wishbone 14 outside the perimeter of the chassis 2 to prevent the chassis 2 and the rear lower wishbone 22 from interfering with each other. However, the axis of rotation of the rear lower wishbone 22 extends directly from the front lower wishbone mount 30 to the rear lower wishbone mount 1620 and thus (a) intersects the chassis, and (b) is non-parallel with the longitudinal axis of the vehicle—both of which are characteristics which are not expected of a double wishbone suspension assembly.

Referring to FIG. 7, a rear view of the vehicle 1 is shown. It can be seen from FIG. 7 that the rear upper wishbone 14 is shorter (extends less far from its mounting point to the chassis) than the rear lower wishbone 22. This induces negative camber when the suspension is compressed (rises), improving stability on cornering. The positions of the mounting points 12 and 20 on the rear of the chassis structure can also be seen in FIG. 7.

Comparing the present design to previous designs of human-propelled vehicles, prior designs use equal length front wishbones which allow the front wheel to travel up and down maintaining a parallel path to the main chassis and in a vertical plane. Ordinarily this is acceptable, however using spoke bicycle type wheels, as is the case here, creates a problem as this type of wheel is not designed to cope with lateral forces during cornering. Also the vertical wheel path can increase stresses on the chassis and wheels when negotiating obstacles.

To address these issues the present design utilises un-equal length upper and lower wishbones. The longer lower wishbone allows the wheel path to move in an arc as it rises reducing the lateral stresses on the wheel during cornering. In addition, the raised angle section on the front of the chassis allows the wishbones to move in a rearward path as they rise, to allow the front wheels to self-centre if the rider lets go of the handle bars, and to reduce stresses on the chassis and wheels when negotiating obstacles.

In a prior design of vehicle in which rear suspension is achieved using rear trailing arms, the trailing arms are mounted to the main chassis by mounting point. The position of the rider is between that mounting point and the rear of the chassis. This creates a pendulum effect over working the damper units causing excessive heat built up and eventual failure of damping forces within the damper units. To address this issue the present design utilises a double wishbone set on the rear. The asymmetrical front and rear connection to the chassis and the modified wishbone shape which follows the perimeter of the chassis makes such a double wishbone design viable in the space available. With this set up the rider is positioned between the rear wishbone mounts, and thus no pendulum effect occurs and the damper units are not over worked.

It will be appreciated that the present technique is not limited to a specific set of dimensions. However, it has been found that configuring the rear double wishbone suspension assembly based on the following guidelines results in a human-propelled vehicle which meets the track width requirements while offering an appropriate suspension performance. As a guideline, the rear coupling point for each wishbone should be approximately half of the horizontal distance from the longitudinal axis of the vehicle than the front coupling point of that wishbone.

The front coupling point of each upper wishbone may be at a horizontal distance of between approximately 175 mm and 200 mm from the longitudinal axis. This range is suitable for a typical chassis width for a human-propelled vehicle. In the present example, the front coupling point of each upper wishbone is at a horizontal distance of approximately 190 mm from the longitudinal axis, and is more specifically at 187.5 mm. Similarly, the front coupling point of each lower wishbone may be at a horizontal distance of between approximately 150 mm and 175 mm from the longitudinal axis, again based on a typical chassis width. In the present example, the front coupling point of each lower wishbone is at a horizontal distance of approximately 160 mm from the longitudinal axis, and is more specifically at 162.5 mm.

The rear coupling point of each rear wishbone may be at a horizontal distance of between approximately 0 mm and 150 mm from the longitudinal axis. At distance of 0 mm would require the rear wishbones at each side of the vehicle to be co-mounted together. This is possible, but would subject one single part of the chassis to stresses from both shocks from both sides—increasing the likelihood of failure. Accordingly, it is preferred that there be some separation between the rear coupling points on either side of the vehicle. Accordingly, preferably the rear coupling point of each rear wishbone is at a horizontal distance of greater than approximately 50 mm from the longitudinal axis.

In order to provide sufficient travel at the upright, the rear coupling point of each wishbone should be at a horizontal distance of less than approximately 125 mm from the longitudinal axis. In the case of the upper wishbones, the rear coupling point of each upper wishbone should be at a horizontal distance of approximately 100 mm from the longitudinal axis. In the case of the lower wishbones, the rear coupling point of each lower wishbone should be at a horizontal distance of approximately 75 mm from the longitudinal axis.

1. A human-propellable vehicle, comprising:
a chassis; and
a rear wheel assembly mounted to a rear portion of the chassis;
wherein the rear wheel assembly comprises a double wishbone suspension assembly, each wishbone of the double wishbone suspension assembly being coupled to the chassis at first and second coupling points, the second coupling point for each wishbone being closer to the rear of the chassis, and closer to the longitudinal axis of the vehicle, than the first coupling point for that wishbone.

2. A human-propellable vehicle according to claim 1, wherein each upper wishbone of the double wishbone suspension assembly is shaped to extend around the outside edge of the chassis from the first coupling point to the second coupling point.

3. A human-propellable vehicle according to claim 1, wherein each lower wishbone of the double wishbone suspension assembly is shaped to extend around the outside edge of the chassis from the first coupling point to the second coupling point.

4. A human-propellable vehicle according to claim 1, comprising a seat, mounted to the chassis between the first coupling points and the second coupling points of the double wishbone suspension assembly.

5. A human-propellable vehicle according to claim 1, comprising a pair of dampers, each damper being mounted between a third coupling point on the chassis and one of the lower wishbones of the double wishbone suspension assembly.

6. A human-propellable vehicle according to claim 1, wherein each wishbone of the double wishbone suspension assembly comprises a first arm having at one end a ball joint engaged with the chassis at the first coupling point, and a second arm having at one end a ball joint engaged with the chassis at the second coupling point, the first and second arms extending around part of the perimeter of the chassis to meet.

7. A human-propellable vehicle according to claim 1, wherein the axis of rotation of each wishbone of the double wishbone suspension assembly intersects the rear portion of the chassis.

8. A human-propellable vehicle according to preceding claim 1, wherein the second coupling point is at substantially the rearmost part of the chassis.

9. A human-propellable vehicle according to claim 1, wherein the chassis is a frame structure of tubular members, and wherein the second coupling point of each of the wishbones is on a rear tubular member of the chassis frame which forms the rear of the chassis.

10. A human-propellable vehicle according to claim 1, wherein the second coupling point for each wishbone is approximately half of the horizontal distance from the longitudinal axis than the first coupling point of that wishbone.

11. A human-propellable vehicle according to claim 1, wherein the first coupling point of each upper wishbone is at a horizontal distance of between approximately 175 mm and 200 mm from the longitudinal axis.

12. A human-propellable vehicle according to claim 11, wherein the first coupling point of each upper wishbone is at a horizontal distance of approximately 190 mm from the longitudinal axis.

13. A human-propellable vehicle according to claim 1, wherein the first coupling point of each lower wishbone is at a horizontal distance of between approximately 150 mm and 175 mm from the longitudinal axis.

14. A human-propellable vehicle according to claim 13, wherein the first coupling point of each lower wishbone is at a horizontal distance of approximately 160 mm from the longitudinal axis.

15. A human propellable vehicle according to claim 1, wherein the second coupling point of each wishbone is at a horizontal distance of between approximately 0 mm and 150 mm from the longitudinal axis.

16. A human-propellable vehicle according to claim 15, wherein the second coupling point of each wishbone is at a horizontal distance of less than approximately 125 mm from the longitudinal axis.

17. A human-propellable vehicle according to claim 16, wherein the second coupling point of each wishbone is at a horizontal distance of greater than approximately 50 mm from the longitudinal axis.

18. A human propellable vehicle according to claim 13, wherein the second coupling point of each upper wishbone is at a horizontal distance of approximately 100 mm from the longitudinal axis.

19. A human propellable vehicle according to claim 13, wherein the second coupling point of each lower wishbone is at a horizontal distance of approximately 75 mm from the longitudinal axis.

20. A human-propellable vehicle according to claim 1, wherein the double wishbone suspension assembly of the rear wheel assembly comprises upper wishbones and lower wishbones, the upper wishbones extending further from their axis of rotation than the lower wishbones.

21. A human-propellable vehicle according to claim 1, comprising a front wheel assembly mounted to a front portion of the chassis, the front wheel assembly comprising a double wishbone suspension assembly, the double wishbone suspension assembly of the front wheel assembly having a positive caster.

22. A human-propellable vehicle according to claim 21, wherein the double wishbone suspension assembly of the front wheel assembly comprises upper wishbones and lower wishbones, the upper wishbones extending further from their axis of rotation than the lower wishbones.

23. A human-propellable vehicle according to claim 1, wherein the vehicle is a three or four wheeled bike.
